(19) United States
(12) Patent Application Publication
(10) Pub. No.: US 2011/0138155 A1
(43) Pub. Date: Jun. 9, 2011

(54) VECTOR COMPUTER AND INSTRUCTION CONTROL METHOD THEREFOR

(76) Inventor: EIICHIRO KAWAGUCHI, Tokyo (JP)

(21) Appl. No.: 12/957,913

(22) Filed: Dec. 1, 2010

(30) Foreign Application Priority Data
Dec. 4, 2009 (JP) P2009-276535

(51) Int. Cl. G06F 9/302

(52) U.S. Cl. 712/222; 712/E09.017

(57) ABSTRACT

A vector computer executing vector operations via vector pipeline processing is restructured to dynamically perform an overtaking control on vector gather/scatter instructions. Minimum/maximum values among vector elements of vector registers are determined based on the result of fixed-point calculation defining an address dependency source instruction in accordance with a vector gather/scatter instruction, wherein minimum/maximum values are determined in a redundant time owing to a short turnaround time of the fixed-point calculation compared to floating-point calculation. An access range of addresses attributed to the vector gather/scatter instruction is specified based on minimum/maximum values. An overtaking control is performed on the vector gather/scatter instruction in light of the access range of addresses.

The present application claims priority on Japanese Patent Application No. 2009-276535, the content of which is incorporated herein by reference.

### BACKGROUND OF THE INVENTION

1. Field of the Invention

The present invention relates to vector computers which perform vector operations via vector pipeline processing. In particular, the present invention relates to instruction control methods of vector computers such as overtaking controls of vector gather instructions and vector scatter instructions.

2. Description of the Related Art

Conventionally, vector processing methods aiming at high-speed processing have been designed to achieve high-speed memory accesses via overtaking controls, which allow memory accesses of subsequent load instructions to precede memory accesses of preceding store instructions when accessed areas of subsequent load instructions do not overlap accessed areas of preceding store instructions.
Patent Document 1: Japanese Patent Application Publication No. H09-231203
Patent Document 2: Japanese Patent Application Publication No. 2002-32361

Patent Document 1 discloses an example of an overtaking control of vector store instructions, wherein vector store instructions and load instructions, in which memory access addresses and areas have been already defined upon reception of requests, are subjected to overtaking control procedures.

In this connection, vector gather instructions and vector scatter instructions perform memory accesses with elements of vector registers serving as effective addresses; hence, complex procedures are needed when calculating accessed areas and making overtaking determinations when executing instructions.

FIG. 16 illustrates an example of a vector gather instruction; and FIG. 17 illustrates a vector scatter instruction. The vector gather instruction of FIG. 16 is a procedure of loading data from memory, in which a source-operand vector register 511 stores load-destination addresses as its elements so that data disposed at addresses designated by the vector register 511 are each stored in counterpart elements of a destination vector register 513 via a memory space 512. In this case, the memory space 512 needs complex memory accesses as shown in FIG. 16.

The vector scatter instruction of FIG. 17 is a procedure of storing data in memory, in which a source-operand vector register 611 stores data as its elements whilst a source-operand vector register 613 stores store-destination addresses as its elements so that data of the vector register 611 are each stored at addresses designated by the vector register 613 via a memory space 612. In this case, the memory space 612 needs complex memory accesses as shown in FIG. 17.

To cope with the above drawback, Patent Document 2 discloses a technology for performing an overtaking control via a static analysis for checking an address dependency using a compiler with respect to a vector gather/scatter instruction. However, the technology of Patent Document 2 is unable to perform an overtaking control in the situation disabling a static analysis for checking an address dependency.

In Patent Document 2, an access range for a vector gather/scatter instruction is specified via a static analysis for checking an address dependency using a compiler in such a way that a first address and a last address are added to the vector gather/scatter instruction, thus achieving an overtaking control on a list vector. In particular, Patent Document 2 presupposes instructions of array accesses so that an access range can be specified by adding a first address and a last address defining a certain array to a list vector instruction.

FIG. 18 illustrates a comparison between static and dynamic analysis with respect to vector gather/scatter instructions. Vector gather/scatter instructions differ from vector load/store instructions such that vector gather/scatter instructions do not have a regularity of memory access; this makes it difficult to detect an address dependency. In the case of a static analysis on a vector gather/scatter instruction having an access range from an address A[4] to an address a[n−3], for example, an address dependency needs to be checked on an accessible range from an address A[0] to an address A[n] if an accessed element is unknown. Hence, an overtaking control is limited to a special situation in which a static analysis succeeds at checking an address dependency. Even though a static analysis succeeds to check an address dependency with respect to an array, it needs to broaden a checked range of an address dependency compared to an actual address range. In contrast, a dynamic analysis narrows down a checked range of an address dependency compared to a static analysis; hence, the dynamic analysis likely increases the number of overtaking patterns.

### SUMMARY OF THE INVENTION

The present invention aims at a vector computer handling vector gather/scatter instructions without causing the above problem. It is an object of the present invention to provide an instruction control method which allows the vector computer to dynamically perform an overtaking control on vector gather/scatter instructions.

The present invention is directed to a vector computer executing vector operations via vector pipeline processing. The vector computer of the present invention is constituted of a minimum/maximum value determination unit which determines minimum/maximum values among vector elements of vector registers based on the result of fixed-point calculation defining an address dependency source instruction in accordance with a vector gather/scatter instruction, a minimum/maximum value register which stores minimum/maximum values determined by the minimum/maximum value determination unit, and an overtaking control unit which specifies an access range of addresses attributed to the vector gather/scatter instruction based on minimum/maximum values stored in the minimum/maximum value register, thus performing an overtaking control on the vector gather/scatter instruction.

The present invention is further directed to an instruction control method which allows a vector computer to proceed with steps of determining minimum/maximum values among vector elements of vector registers based on the result of fixed-point calculation defining an address dependency source instruction in accordance with a vector gather/scatter instruction, storing minimum/maximum values determined, and specifying an access range of addresses attributed to the vector gather/scatter instruction based on minimum/maximum values, thus performing an overtaking control on the vector gather/scatter instruction.

In the above, minimum/maximum values can be determined during a redundant time owing to a short turnaround time of fixed-point calculation compared to floating-point calculation.

Since the present invention is able to dynamically detect an address dependency source instruction with respect to vector gather/scatter instructions, it is possible to increase the number of overtaking patterns in comparison to static detection of an address dependency source instruction. This is because the present invention provides a possibility of allowing for an overtaking control on vector gather/scatter instructions which normally disables an overtaking determination via static analysis. In addition, the present invention is able to precisely specify an access range of addresses which are detected based on minimum/maximum values of list vectors. In other words, the present invention may increase the chance of circumventing an overtaking determination since the present invention narrows down an access range of addresses via dynamic analysis rather than static analysis.

### BRIEF DESCRIPTION OF THE DRAWINGS

These and other objects, aspects, and embodiments of the present invention will be described in more detail with reference to the following drawings.

FIG. 1 is a block diagram showing the constitution of a vector computer according to a first embodiment of the present invention.

FIG. 2 shows a plurality of vector elements included in each vector register incorporated in the vector computer shown in FIG. 1.

FIG. 3 illustrates an example of the vector pipeline processing adapted to the vector computer of the first embodiment.

FIG. 4 illustrates detailed connections between vector elements and vector pipelines.

FIG. 5 is a block diagram showing the internal constitution of a minimum/maximum value determination unit included in the vector computer shown in FIG. 1.

FIG. 6 illustrates an overtaking pattern in which a vector gather instruction overtakes a vector store instruction.

FIG. 7 is a flowchart showing an overtaking determination process in which a vector gather instruction overtakes a vector store instruction.

FIG. 8 illustrates an overtaking pattern in which a vector load instruction overtakes a vector scatter instruction.

FIG. 9A is a timing chart showing the relationship of turnaround times between floating-point calculation and fixed-point calculation.

FIG. 9B is a timing chart showing the relationship of turnaround times among floating-point calculation, fixed-point calculation, and minimum/maximum value determination according to the vector computer of the first embodiment.

FIG. 10 is a block diagram showing the constitution of a vector computer according to a second embodiment of the present invention.

FIG. 11 is a flowchart showing an overtaking determination process according to the second embodiment.

FIG. 12 is a block diagram showing the constitution of a vector computer according to a third embodiment of the present invention.

FIG. 13 illustrates masked operations using a mask register interposed between source registers and a destination resister.

FIG. 14 illustrates a vector length (VL) defining a range of vector elements subjected to calculation.

FIG. 15 is a flowchart showing an overtaking determination process according to the third embodiment.

FIG. 16 illustrates an example of a vector gather instruction incurring a complex memory access via a memory space.

FIG. 17 illustrates an example of a vector scatter instruction incurring a complex memory access via a memory space.

FIG. 18 illustrates a comparison between static and dynamic analysis for checking an address dependency with respect to a vector gather/scatter instruction.

### DESCRIPTION OF THE PREFERRED EMBODIMENTS

The present invention will be described in further detail by way of examples with reference to the accompanying drawings.

### 1. First Embodiment

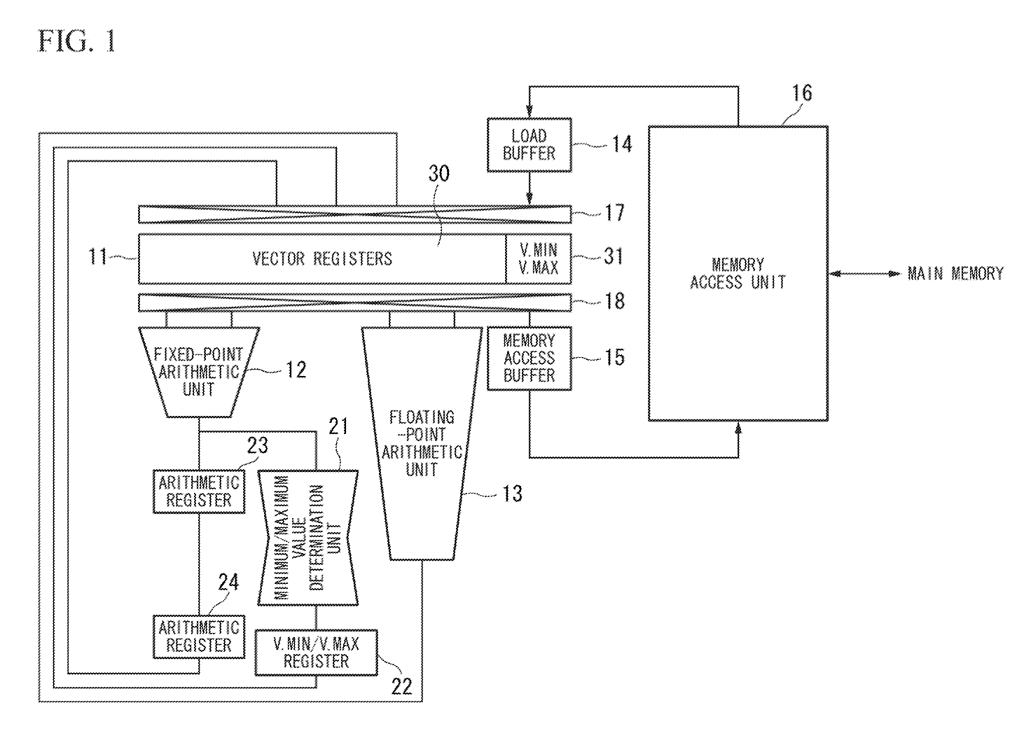

FIG. 1 is a block diagram showing the constitution of a vector computer according to a first embodiment of the present invention. The vector computer of the first embodiment is constituted of vector registers 11, a fixed-point arithmetic unit 12, a floating-point arithmetic unit 13, a load buffer 14, a memory access buffer 15, and a memory access unit 16, wherein functions of those blocks are similar to those of a conventionally-known vector computer. The vector computer further includes a minimum/maximum value determination unit 21, a minimum/maximum value register 22 (V.MIN/MAX), and arithmetic registers 23, 24 retaining arithmetic results.

The vector registers 11 are each used for vector operations. Each vector register includes a plurality of elements (e.g. 128-512 elements). The functionality of each vector register 11 is divided into a main register section 30 and a minimum/maximum value register section 31 (V.min, V.max) retaining minimum/maximum values of vector elements.

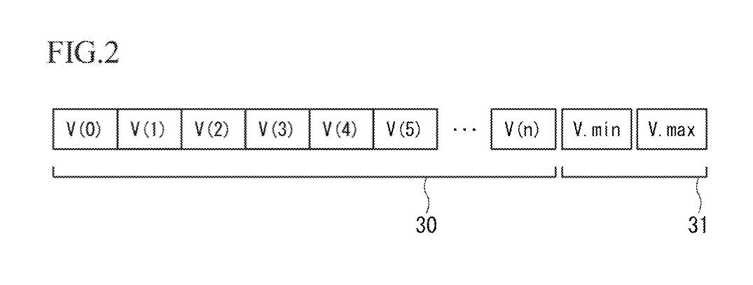

FIG. 2 shows one vector register 11 including a plurality of elements (e.g. 128 elements). For example, the vector register 11 includes 128 vector registers, each of which further includes 128 elements.

Specifically, one vector register is constituted of the main register section 30 and the minimum/maximum value register section 31. The main register section 30 stores vector elements V(0), V(1), V(2), . . . , V(n), whilst the minimum/maximum register section 31 stores a minimum value V.min and a maximum value V.max within the vector elements V(0) through V(n). The minimum/maximum resister section 31 serves as a cache register. The minimum value V.min and the maximum value V.max are used to specify an access range during an overtaking control of a vector gather/scatter instruction.

Interconnect networks 17 and 18 are built in at upper and lower sections of the vector registers 11. The interconnect network 17 serves as a circuit for selecting a write destination of arithmetic result and load data, whilst the interconnect network 18 serves as a circuit for selecting a destination of data sent from registers to the arithmetic unit or the memory access buffer 15.

The fixed-point arithmetic unit 12 performs fixed-point calculation whilst the floating-point arithmetic unit 13 performs floating-point calculation.

The load buffer 14 temporarily stores load data returned from the memory access unit 16. The memory access buffer 15 temporarily stores store addresses, store data and load addresses.

The memory access unit 16 accesses a main memory (not shown). In the vector computer of the first embodiment, the memory access unit 16 has an overtaking determination function.

The minimum/maximum value determination unit 21 determines minimum/maximum values of vector elements based on the calculation result of the fixed-point arithmetic unit 12. Addresses for accessing the memory space with vector gather/scatter instructions have been likely produced based on results of fixed-point arithmetic units with respect to address dependency source instructions. For this reason, the vector computer of the first embodiment is designed such that the minimum/maximum value determination unit 21 produces maximum/minimum values of vector elements based on the calculation result of the fixed-point arithmetic unit 12.

Since access addresses of vector gather/scatter instructions are integer data, another minimum/maximum value determination unit is not needed at the output side of the floating-point arithmetic unit 13.

The minimum/maximum value register 22 retains minimum/maximum values calculated by the minimum/maximum value determination unit 21. Minimum/maximum values are calculated by the minimum/maximum value determination unit 21 and temporarily stored in the minimum/maximum value register 22; subsequently, minimum/maximum values are each transferred to the minimum/maximum value register section 31 of each vector register 11.

The arithmetic registers 23 and 24 perform round-robin operations to arbitrate the output timing of the minimum/maximum value determination unit 21.

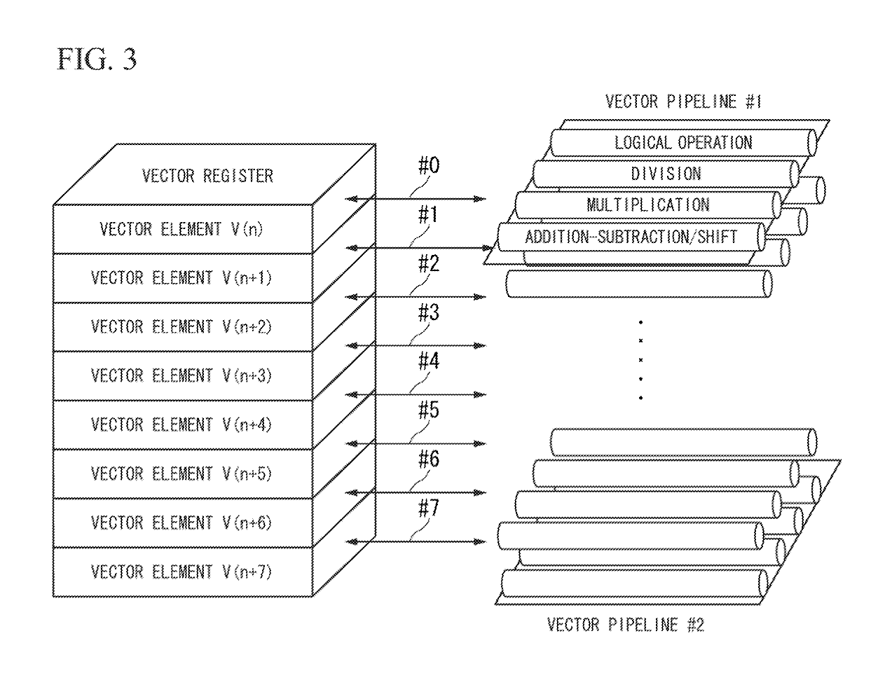

FIG. 3 illustrates an example of the vector pipeline processing adapted to the vector computer of the first embodiment. The vector register shown in FIG. 3 handles eight vector pipelines #0, #1, #2, . . . , #7, each of which is configured of operators implementing an addition-subtraction/shift operation, a multiplication, a division and a logic operation. The eight pipe lines #0 through #7 are connected with eight vector elements V(n) through V(n+7) respectively.

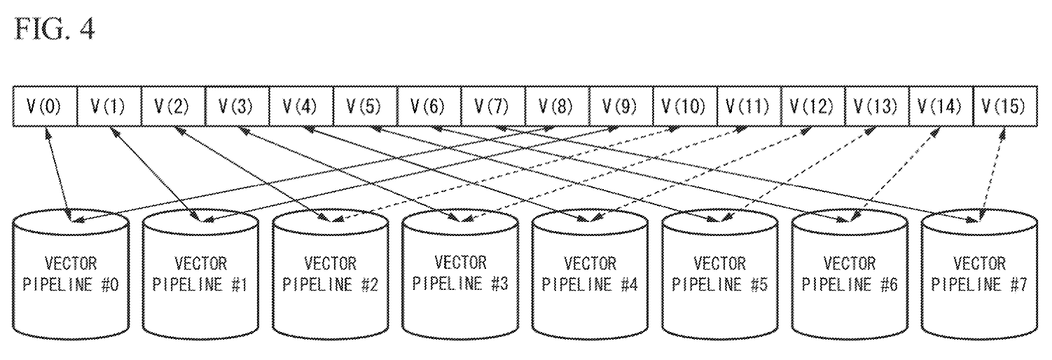

FIG. 4 shows detailed connections between vector elements and vector pipelines, wherein sixteen vector elements V(0) through V(15) are connected with eight vector pipelines #0 through #7. That is, the vector elements V(0) and V(8) are connected to the vector pipeline #0, while the vector elements V(1) and V(9) are connected to the vector pipeline #1. These connections are repeated in light of the maximum number of vector elements; hence, vector elements having different numbers are connected to different pipelines.

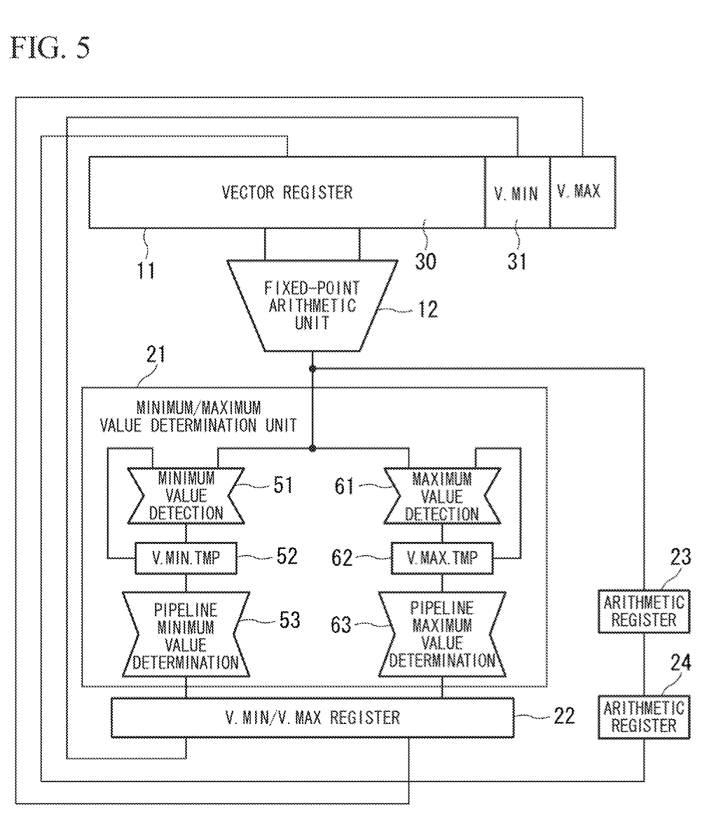

FIG. 5 is a block diagram illustrating the internal constitution of the minimum/maximum value determination unit 21 in the vector computer shown in FIG. 1. The minimum/maximum value determination unit 21 is constituted of a minimum value detection unit 51, a register 52 (V.min.tmp), a pipeline minimum value determination unit 53, a maximum value detection unit 61, a register 62 (V.max.tmp), and a pipeline maximum value determination unit 63.

Since access addresses of vector gather/scatter instructions are fixed-point data (i.e. integer data), the fixed-point arithmetic unit 12 outputs its calculation result in each cycle at a fixed-point arithmetic mode.

Since each vector register normally handles a plurality of vector pipelines, the fixed-point arithmetic unit 12 handling the vector pipeline 40 produces calculation results with respect to a pair of vector elements V(0), V(8), a pair of vector elements V(16), V(24), . . . . Similarly, the fixed-point arithmetic unit 12 handing the pipeline #1 produces calculation results with respect to a pair of vector elements V(1), V(9), a pair of vector elements V(17), V(25), . . . .

In FIG. 5, the minimum value detection unit 51 detects a minimum value from among calculation results produced by the fixed-point arithmetic unit 12. The register 52 temporarily retains the minimum value detected by the minimum value detection unit 51. Since the fixed-point arithmetic unit 12 produces its calculation result in each cycle, the minimum value detection unit 51 compares the value of the register 52 with the calculation result of the fixed-point arithmetic unit 12, so that a smaller value is selected and retained in the register 52.

The maximum value detection unit 61 detects a maximum value from among calculation results produced by the fixed-point arithmetic unit 12. The register 62 retains the maximum value detected by the maximum value detection unit 61. Since the fixed-point arithmetic unit 12 produces its calculation result in each cycle, the maximum value detection unit 61 compares the value of the register 62 with the calculation result of the fixed-point arithmetic unit 12, so that a smaller value is selected and retained in the register 62.

Through the above comparison, vector pipelines are each able to detect minimum/maximum values. For example, the vector pipeline #0 detects minimum/maximum values from among the vector elements V(0), V(8), V(16), V(24), V(32), V(40), V(48), . . . .

Since the vector computer handles a plurality of vector pipelines, a further comparison needs to be performed between vector pipelines in order to detect final minimum/maximum values among all vector elements. The pipeline minimum value determination unit 53 and the pipeline maximum value determination unit 63 are used to detect final minimum/maximum values among vector pipelines. In this connection, the pipeline minimum/maximum value determinations are not necessarily performed in each cycle, but they can be performed at the timing of finalizing all elements of vector pipelines.

The minimum/maximum value register 22 stores final minimum/maximum values determined by the pipeline minimum value determination unit 53 and the pipeline maximum value determination unit 63 among all vector elements. At the timing identical to the write-back timing for writing back the calculation result with respect to the last vector element, the final minimum/maximum values temporarily retained in the minimum/maximum value register 22 are written back into the minimum/maximum value register section 31 of each vector register 11.

In the vector computer of the first embodiment, the minimum/maximum value determination unit 21 determines minimum/maximum values among vector elements based on calculation results of the fixed-point arithmetic unit 12. This makes it possible to specify the access range with respect to vector gather/scatter instructions, thus enabling an overtaking control on vector gather/scatter instructions. Details of this overtaking control will be described below.

The following description refers to a vector store instruction (VST), a vector load instruction (VLD), a vector addition instruction (VADX), a vector gather instruction (VGT), and a vector scatter instruction (VSC). In addition, $v0, $v1, $v2, . . . denote indexes of vector registers, while s0, s1, s2, . . . denote indexes of scalar registers.

A first example of an overtaking pattern refers to the situation in which a vector gather instruction overtakes a vector store instruction in the vector computer of the first embodiment.

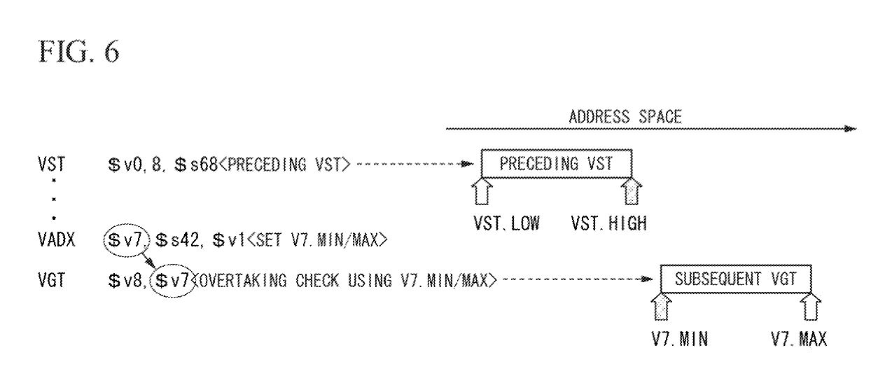

FIG. 6 illustrates the overtaking patter in which the vector gather instruction overtakes the vector store instruction, wherein the vector computer of the first embodiment performs a sequence of instructions as follows.

$$\begin{matrix}VST & \$ v 0 , 8 , \$ v 68 ; \\ VADX & \$ v 7 , \$ s 42 , \$ v 1 ; \\ & … \\ VGT & \$ v 8 , \$ v 7 ;\end{matrix}$$

The first line refers to an instruction (VST $v0, 8, $v68), which is a normal vector store instruction whose access range can be easily calculated. In FIG. 6, the vector store instruction defines an access range commensurate with a memory space between an address (VST.Low) and an address (VST.High).

The second line refers to a vector addition instruction (VADX $v7, $s42, $v1), in which the value of the scalar register ($s42) is added to all vector elements of the vector register ($v1) so that the addition result is stored in the vector register ($v7). This instruction may serve as an address dependency source instruction with respect to the vector gather instruction.

At this time, the fixed-point arithmetic unit 12 performs calculation according to the vector addition instruction; this allows the minimum/maximum value determination unit 21 to determine a memory space accessible via the vector gather instruction based on the calculation result of the fixed-point arithmetic unit 12. When a vector element of the vector register ($v7) is set to “256”, for example, a minimum value ($v7.min) and a maximum value ($v7.max) are selected from among “256” vector elements which are produced by adding the content of the vector register ($v1) and the content of the scalar register ($s42) with the fixed-point arithmetic unit 12, so that those values define the memory space accessible via the vector gather instruction. The minimum/maximum value determination unit 21 calculates the minimum value ($v7.min) and the maximum value ($v7.max) based on the calculation result of the fixed-point arithmetic unit 12. The minimum value ($v7.min) and the maximum value ($v7.max) are set to the minimum/maximum value register section 31 of the vector register 11 via the minimum/maximum value register 22.

The next line refers to a vector gather instruction (VGT $v8, $v7), which is executed using the content of the vector register ($v7) calculated via the vector addition instruction. At this time, the minimum/maximum value determination unit 21 reads the minimum value ($v7.min) and the maximum value ($v7.max), which are set to the minimum/maximum value register 31, in addition to the content of the vector register ($v7). The minimum value ($v7.min) and the maximum value ($v7.max) designate a low address and a high address accessible via the vector gather instruction. Thus, it is possible to recognize the access range of the vector gather instruction.

In the case of FIG. 6, the preceding vector store instruction refers to the access range between the high address (VST.Low) and the low address (VST.High), whilst the subsequent vector gather instruction refers to the access range between the address (V7.min) and the address (V7.max). Since the high address (VST.High) of the preceding vector store instruction is lower than the low address (v7.min) of the subsequent vector gather instruction, the subsequent vector gather instruction is able to overtake the preceding vector store instruction.

An overtaking control allowing for the subsequent vector gather instruction overtaking the vector store instruction is similar to a determination process allowing for the vector store instruction overtaking the vector load instruction; hence, the vector gather instruction is able to overtake the vector store instruction. In this connection, it is possible to employ a known overtaking determination method.

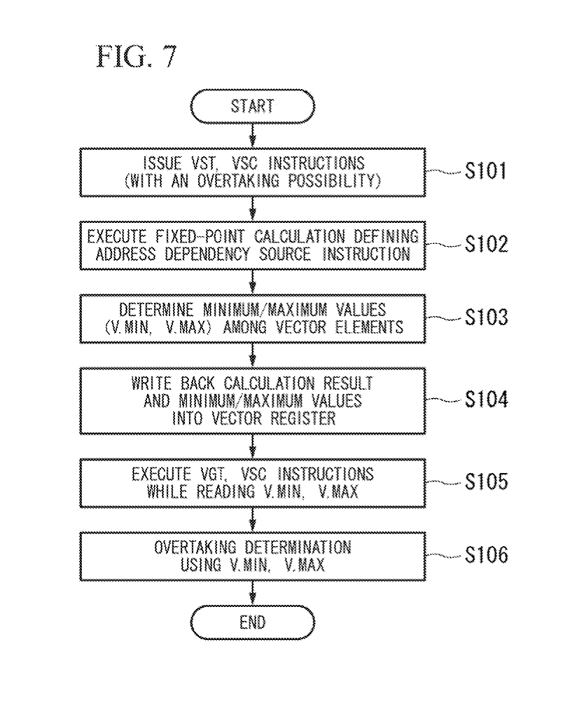

Next, an example of the overtaking determination process will be described with reference to FIG. 7. FIG. 7 is a flowchart showing an overtaking determination process allowing for the vector gather instruction overtaking the vector store instruction. First, the vector computer issues the preceding vector store instruction (VST), i.e. (VST $v0, 8, $v68) shown in FIG. 6, in step S101. The preceding vector store instruction has a chance of being overtaken by the subsequent vector gather instruction. The vector store instruction is sent to the memory access unit 16 via the memory access buffer 15. When the vector computer does not enable immediate issuance of the vector store instruction due to a speculation in progress, for example, the vector store instruction is held in the memory access unit 16 until its issuance is permitted.

Next, the vector computer performs fixed-point calculation defining an address dependency source instruction according to the vector addition instruction (VADX $v7, $s42, $v1) (see FIG. 6) in step S102. That is, the fixed-point arithmetic unit 12 performs the vector addition instruction (VADX $v7, $s42, $v1).

The minimum/maximum value determination unit 21 determines the minimum value (V.min) and the maximum value (V.max) among vector elements based on the calculation result of the fixed-point arithmetic unit 12 in step S103. Subsequently, the calculation result of the vector addition instruction, the minimum value (V.min) and the maximum value (V.max) are written back into the vector register in step S104.

Next, the vector computer issues the subsequent vector gather instruction (VGT), i.e. (VGT $v8, $v7) shown in FIG. 6. At this time, the vector computer reads the load address of the vector register from the Main register section 30 while simultaneously reading the minimum value (V.min) and the maximum value (V.max), which are added to the vector register, from the minimum/maximum register section 31 in step S105. The minimum value (V.min) and the maximum value (V.max) along with the vector gather instruction are sent to the memory access unit 16 via the memory access buffer 15.

The memory access unit 16 performs an overtaking determination with the preceding vector store instruction based on the minimum value (V.min) and the maximum value (V.max) in step S106.

A second example of an overtaking pattern refers to the situation in which the vector load instruction overtakes the vector scatter instruction in the vector computer of the first embodiment.

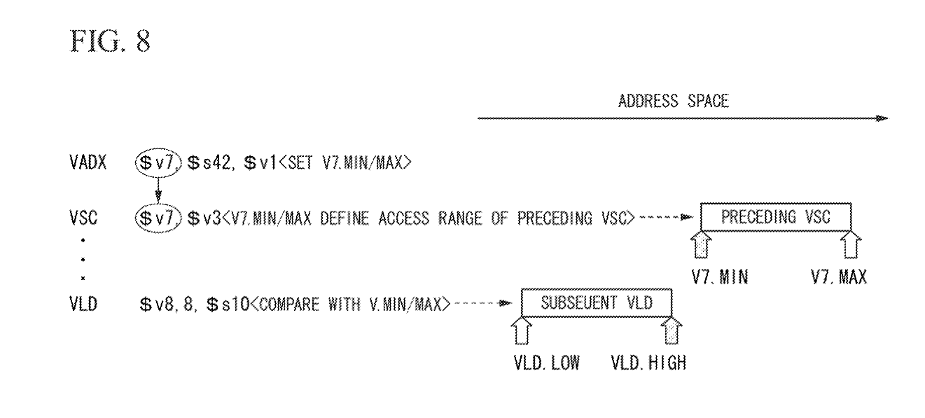

FIG. 8 illustrates the overtaking pattern in which the vector load instruction overtakes the vector scatter instruction, wherein the vector computer of the first embodiment executes a sequence of instructions as follows.

$$\begin{matrix}VADX & \$ v 7 , \$ s 42 , \$ v 1 ; \\ VSC & \$ v 7 , \$ v 3 ; \\ & … \\ VLD & \$ v 8 , 8 , \$ s 10 ;\end{matrix}$$

In FIG. 8, a first line refers to a vector addition instruction (VADX $v7, $s42, $v1), in which the content of the scalar register ($s42) is added to all the vector elements of the vector register ($v1) so that the addition result is stored in the vector register ($v7). This vector addition instruction serves as an address dependency source instruction with respect to the vector scatter instruction.

At this time, the minimum/maximum value determination unit 21 determines the minimum value (v7.min) and the maximum value (v7.max) among all vector elements of the vector register ($v7) completing the vector addition calculation. The minimum value (v7.min) and the maximum value (v7.max) of the vector register ($v7) are set to the minimum/maximum value register section 31 of the vector register 11 via the minimum/maximum value register 22.

A second line refers to a vector scatter instruction (VSC $v7, $s3), which is executed upon accessing the vector register ($v7). The access range of the vector register ($v7) is defined by the minimum value (v7.min) and the maximum value (v7.max) already set to the minimum/maximum value register section 31 of the vector register 11. This allows for the subsequent vector load instruction overtaking the preceding vector scatter instruction.

In FIG. 8, the access range of the preceding vector scatter instruction ranges from the low address (V7.min) to the high address (V7.max), whilst the access range of the subsequent vector load instruction ranges from the low address (VLD.Low) to the high address (VLD.High). Since the low address (V7.min) of the preceding vector caster instruction is higher than the high address (VLD.High) of the subsequent vector load instruction, the subsequent vector load instruction is able to overtake the preceding vector scatter instruction.

In the above description, FIG. 6 illustrates the overtaking pattern in which the vector gather instruction overtakes the vector store instruction, whilst FIG. 8 illustrates the overtaking pattern in which the vector load instruction overtakes the vector scatter instruction. With the same logic used in these patterns, it is possible to control an overtaking pattern in which the vector gather instruction overtakes the vector scatter instruction.

In the vector computer of the first embodiment, the minimum/maximum value determination unit 21 determines the minimum value (V.min) and the maximum value (V.max) based on the calculation result of the fixed-point arithmetic unit 12, thus specifying the access range with respect to the vector gather/scatter instruction. This demonstrates an overtaking control with respect to the vector gather/scatter instruction.

Specifically, the vector computer of the first embodiment realizes an overtaking control architecture for the vector gather/scatter instruction by way of two technical features.

A first technical feature is that vector gather/scatter instructions are each assigned with fixed-point addresses (i.e. integers), which are practically produced via fixed-point calculation of the fixed-point arithmetic unit 12. For this reason, the vector computer determines minimum/maximum values among all vector elements of vector registers based on the calculation result of the fixed-point arithmetic unit 12.

A second technical feature is that for the purpose of simplification of each vector operator, the vector computer combines a turnaround time (TAT) of fixed-point calculation and a turnaround time (TAT) of floating-point calculation. The floating-point calculation has a redundancy of several cycles in the latter part of each TAT due to round robin.

Considering the two technical features, a timing arbitration time can be produced based on maximum/minimum values of calculation results.

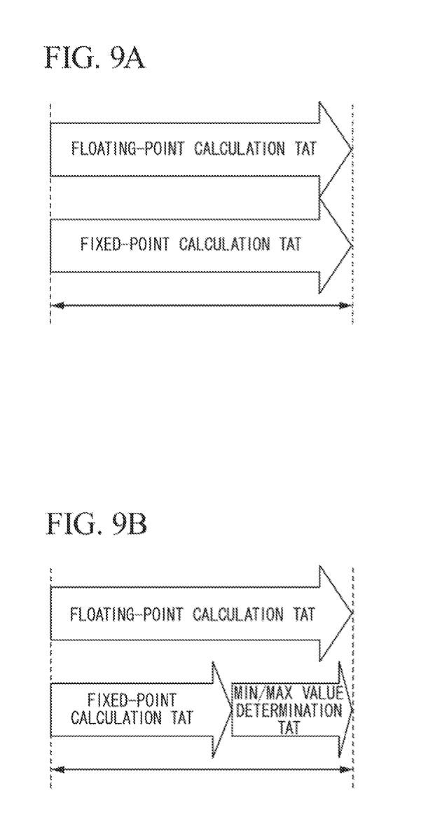

FIGS. 9A and 9B are timing charts showing the relationship between the fixed-point calculation and the floating-point calculation. The fixed-point calculation is completed in one cycle (1T) or so, while the floating-point calculation is completed in four cycles (4T), for example. The turnaround time (TAT) plays an important factor in vector operators, whilst the vector computer needs to handle numerous data and to simplify controls. Normally, the fixed-point calculation TAT and the floating-point calculation TAT are combined together as shown in FIG. 9A. Generally-known vector computers perform timing arbitration via this timing chart.

In contrast, the vector computer of the first embodiment calculates minimum/maximum values via a timing chart of FIG. 9B. Since the fixed-point calculation has a redundancy of turnaround time (TAT) compared to the floating-time calculation, the minimum/maximum value determination unit 21 exploits such a redundant time to calculate minimum/maximum values, thus applying the calculation result to an overtaking control of the vector gather/scatter instruction. In other words, the vector computer of the first embodiment does not need to increase the overall turnaround time (TAT) irrespective of the provision of the minimum/maximum value determination unit 21.

### 2. Second Embodiment

In the first embodiment, address dependency source instructions regarding vector gather/scatter instructions are calculated via fixed-point calculations; hence, as shown in FIG. 9B, the minimum/maximum value determination unit 21 utilizes a difference of turnaround time (TAT) between the fixed-point calculation and the floating-point calculation so as to determine minimum/maximum values based on the calculation result of the fixed-point arithmetic unit 12.

Access addresses for vector gather/scatter instructions are practically calculated via the fixed-point calculation, whereas it is possible to execute vector gather/scatter instructions by use of loaded data of vector registers in accordance with a sequence of instructions as follows.

VLD $v7, 8, $s10;

VGT $v8, $v7;

A first line refers to a vector load instruction (VLD $v7, 8, $s10), in which upon loading data into the vector register ($v7), the vector register ($v7) performs a vector gather instruction. In this case, the vector computer of the first embodiment shown in FIG. 1 is not designed to perform calculation via the fixed-point arithmetic unit 12; hence, the vector computer of the first embodiment is unable to calculate minimum/maximum values (V.min, V.max).

A second embodiment of the present invention facilitates a scheme to calculate minimum/maximum values upon executing vector load instructions, thus handling address dependency source instructions without depending upon the fixed-point calculation.

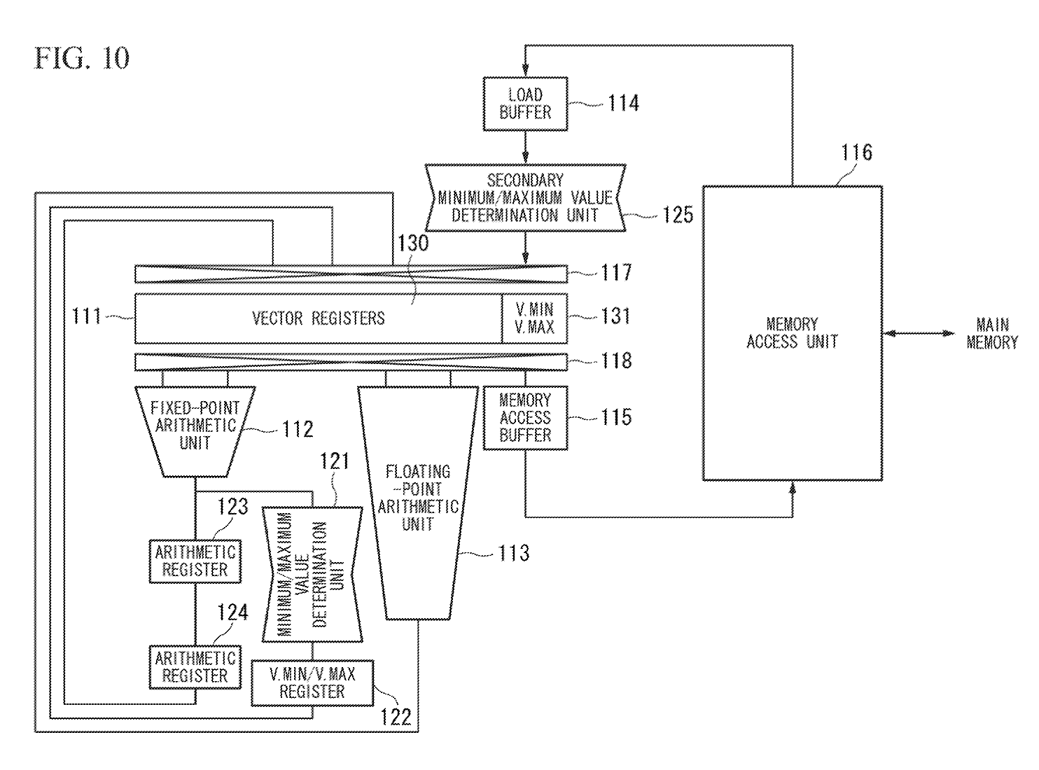

FIG. 10 is a block diagram showing the constitution of a vector computer according to the first embodiment of the present invention. The vector computer of the first embodiment includes vector registers 111, a fixed-point arithmetic unit 112, a floating-point arithmetic unit 113, a load buffer 114, a memory access buffer 115, and a memory access unit 116, functions of which are equivalent to the vector registers 11, the fixed-point arithmetic unit 12, the floating-point arithmetic unit 13, the load buffer 14, the memory access buffer 15, and the memory access unit 16 in the vector computer of the first embodiment shown in FIG. 1. In addition, the vector computer of the second embodiment includes a minimum/maximum value determination unit 121, a minimum/maximum value register 122, arithmetic registers 123 and 124, functions of which are equivalent to the minimum/maximum value determination unit 21, the minimum/maximum value register 22, the arithmetic registers 123 and 124 in the vector computer of the first embodiment. Furthermore, each of the vector registers 111 in the vector computer of the second embodiment is divided into a main register section 130 and a minimum/maximum register section 131 (V.min, V.max), functions of which are equivalent to the main register section 130 and the minimum/maximum register section 131 in the vector computer of the first embodiment.

The vector computer of the second embodiment is characterized by a secondary minimum/maximum value determination unit 125, which determines minimum/maximum values at an intermediate position on the path via which loaded data of the load buffer 114 is transferred and written into the vector register 111.

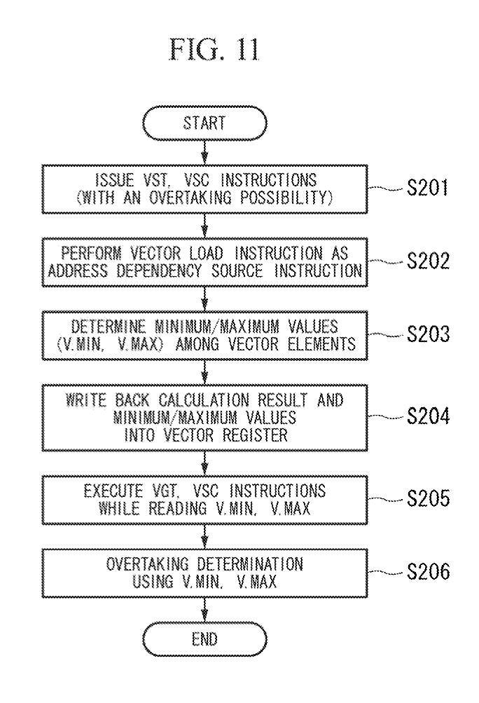

FIG. 11 is a flowchart showing an overtaking determination process implemented in the vector computer of the second embodiment. The overtaking determination process of FIG. 11 is similar to the overtaking determination process of FIG. 7, wherein steps S201 through S206 are equivalent, to steps S101 through S106. The overtaking determination process of the second embodiment is characterized by steps S202 and S203, which differ from steps S102 and S103 in the overtaking determination process according of the first embodiment.

In the overtaking determination process of the first embodiment shown in FIG. 7, step S102 defines an address dependency source instruction via the fixed-point calculation, whereby step 103 describes that the minimum/maximum value determination unit 21 determines minimum/maximum values among vector elements based on the calculation result of the fixed-point arithmetic unit 12. In the overtaking determination process of the second embodiment shown in FIG. 11, step S202 defines an address dependency source instruction via a vector load instruction, whereby step S203 describes that, instead of the minimum/maximum value determination unit 121, the secondary minimum/maximum value determination unit 125 determines minimum/maximum values among vector elements based on loaded data of the load buffer 114.

As described above, the vector computer of the second embodiment is characterized by the provision of the secondary minimum/maximum value determination unit 125 which determines minimum/maximum values among vector elements based on loaded data of the load buffer 114 written into vector registers 111. This makes it possible to perform an overtaking control on vector gather/scatter instructions in light of an address dependency source instruction via a vector load instruction.

### 3. Third Embodiment

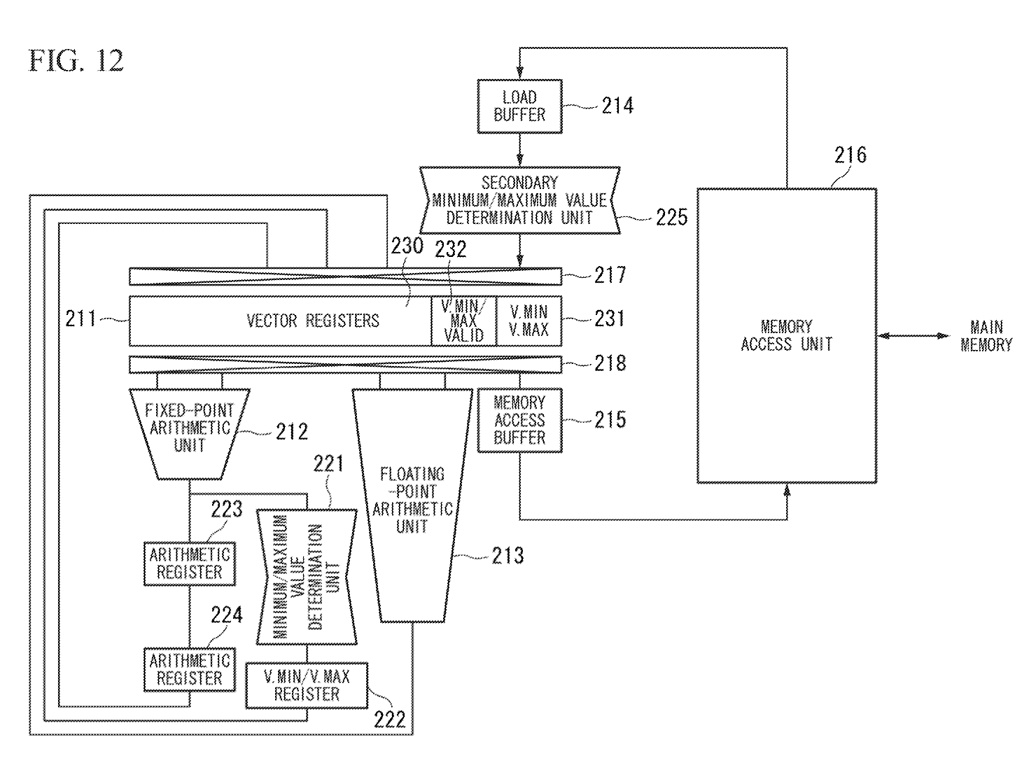

FIG. 12 is a block diagram showing the constitution of a vector computer according to a third embodiment of the present invention. The vector computer of the third embodiment includes vector registers 211, a fixed-point arithmetic unit 212, a floating-point arithmetic unit 213, a load buffer 214, a memory access buffer 215, a memory access unit 216, a minimum/maximum value determination unit 221, a minimum/maximum value register 222 (V.min, V.max), arithmetic registers 223 and 224, and a secondary minimum/maximum value determination unit 225, which are equivalent to the vector registers 111, the fixed-point arithmetic unit 112, the floating-point arithmetic unit 113, the load buffer 114, the memory access buffer 115, the memory access unit 116, the minimum/maximum value determination unit 121, the minimum/maximum value register 122 (V.min, V.max), the arithmetic registers 123 and 124, and the secondary minimum/maximum value determination unit 125 in the vector computer of the second embodiment shown in FIG. 10.

The vector computer of the third embodiment is characterized in that each of the vector registers 211 is divided into three sections, namely a main register section 230, a minimum/maximum register section 231 (V.min, V.max), and a valid/invalid register section 232 (V.min/max, Valid). The valid/invalid register section 232 indicates whether minimum/maximum values set to the minimum/maximum register section 231 are valid or invalid. Specifically, the valid/invalid register section 232 includes a valid bit, wherein “1” indicates a validity while “0” indicates an invalidity, for example.

In the vector computer of the third embodiment, the minimum/maximum value register section 231 is set up in a write-back mode of data from the fixed-point arithmetic unit 212 to the vector register 211, while a valid bit is set to the valid/invalid register section 231 so as to validate the content of the minimum/maximum value register section 231, otherwise, the content of the minimum/maximum value register section 231 is invalidated. This allows for an overtaking determination on vector gather/scatter instructions only when the valid/invalid register section 232 validates the content of the minimum/maximum value register section 231. Otherwise, the vector computer of the third embodiment does not perform an overtaking control.

The foregoing embodiments are each designed to handle the simple situation in which minimum/maximum values are simply determined based on the calculation result of the fixed-point arithmetic unit or minimum/maximum values are simply determined in a write-back mode of data from the load buffer to the vector register.

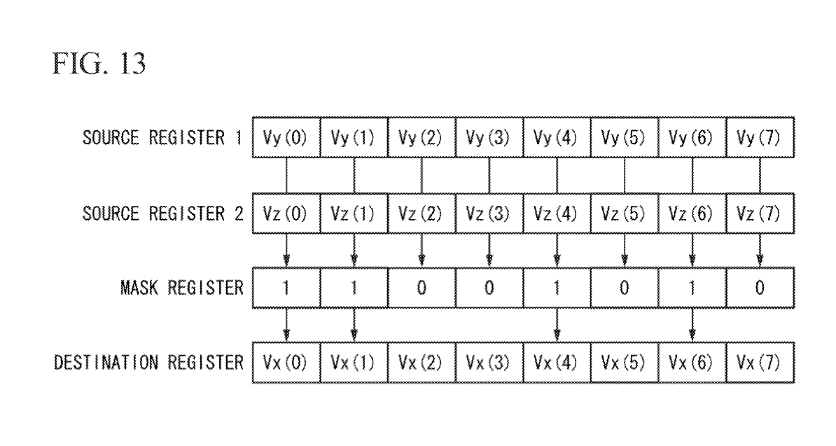

Vector computers are normally involved in masked operations as shown in FIG. 13. Masked operations are performed with respect valid elements of a mask register alone. FIG. 13 shows that mask bits of “1” are set at vector elements 0, 1, 4, and 6, at which calculation is performed to update the counterpart bits of a destination register. On the other hand, calculation is performed at vector element 2, 3, 5, and 7, but the counterpart bits of the destination register are not updated.

In this case, the minimum/maximum value determination unit 221 utilizes the calculation result of the fixed-point arithmetic unit 212 so as to determine minimum/maximum values, however, which may not precisely match actual minimum/maximum values among all vector elements of vector registers owing to masked operations. In this case, the valid/invalid register section 232 invalidates the content of the minimum/maximum register section 231 so as to prevent the vector computer from producing erroneous results.

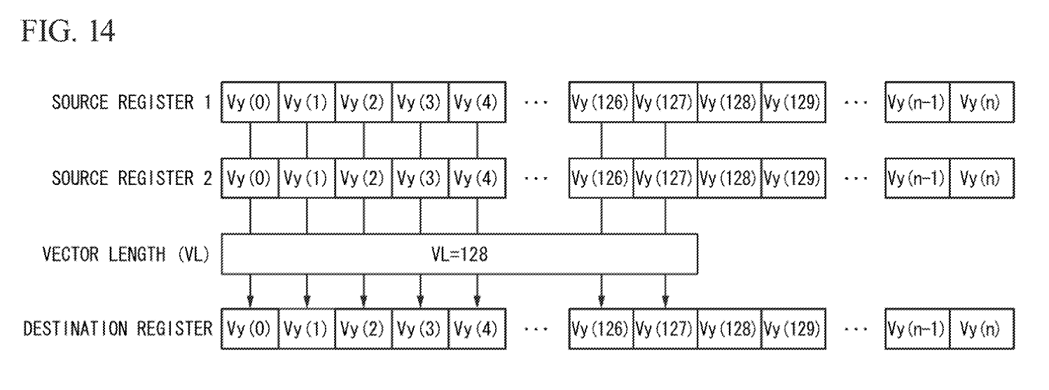

Vector computers implement vector lengths (VL) which can be varied during programs in progress. Vector lengths define a range of vector elements actually subjected to calculation within one vector register. FIG. 14 illustrates a vectorlength (VL), which is set to “128” irrespective of a maximum length (N) of one vector register, so that 128 vector elements (i.e. Vy(0) through Vy(127)) are selected and subjected to calculation.

No problem may occur with respect to the fixed vector length (VL), whereas the vector computer allows for a change of the vector length while running a program. In the overtaking pattern shown in FIG. 6, when the vector length of the vector addition instruction in progress is “128” whilst the vector length of the vector gather instruction is “256”, for example, calculated minimum/maximum values may not match actual minimum/maximum values among all vector elements of vector registers. To cope with a change of the vector length, all the valid/invalid register sections 232 of the vector registers 211 are set to invalidate the contents of the minimum/maximum value register sections 231, thus preventing the vector computer from producing erroneous results.

Normally, the vector length of the vector gather instruction does not need to be changed to “256” although the vector length of the vector addition instruction is set to “128”. In contrast, there is a possibility that the vector length of the vector gather instruction is changed to “128” although the vector length of the vector addition instruction is set to “256”. The former situation causes an error whilst the latter situation does not cause a problem. However, for the purpose of simplifying the processing, the vector computer needs to be designed such that, upon detecting a change of the vector length, all the valid/invalid register sections 232 are controlled to invalidate the contents of the minimum/maximum register sections 231.

In short, it is possible to solve problems owing to masked operations and changed vector lengths by controlling the valid/invalid register sections 232 invalidating the contents of the minimum/maximum register sections 231.

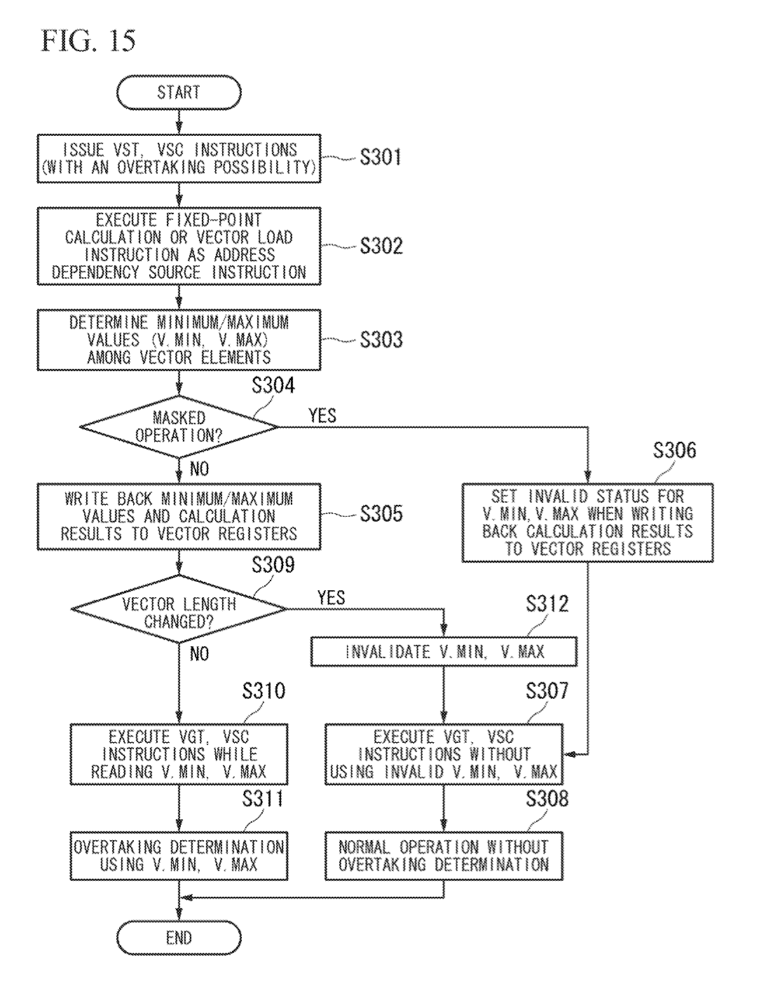

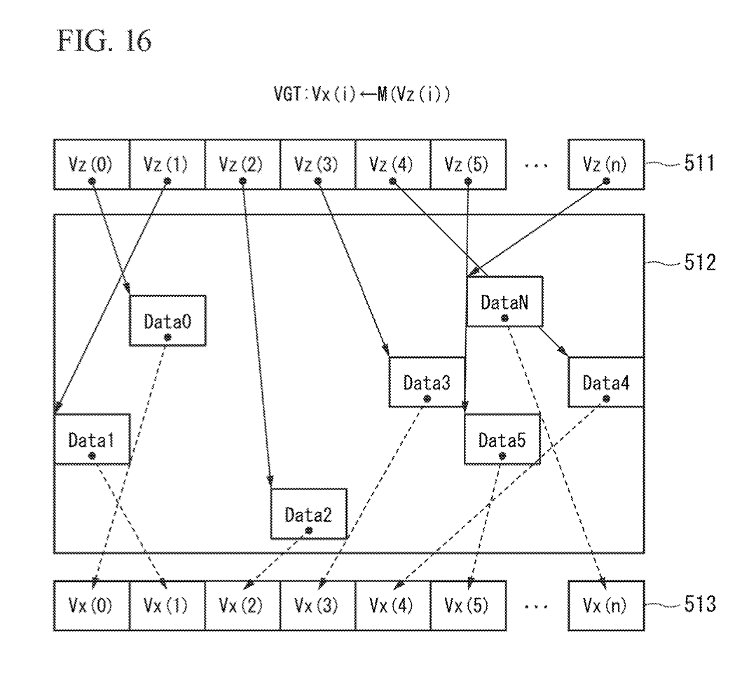

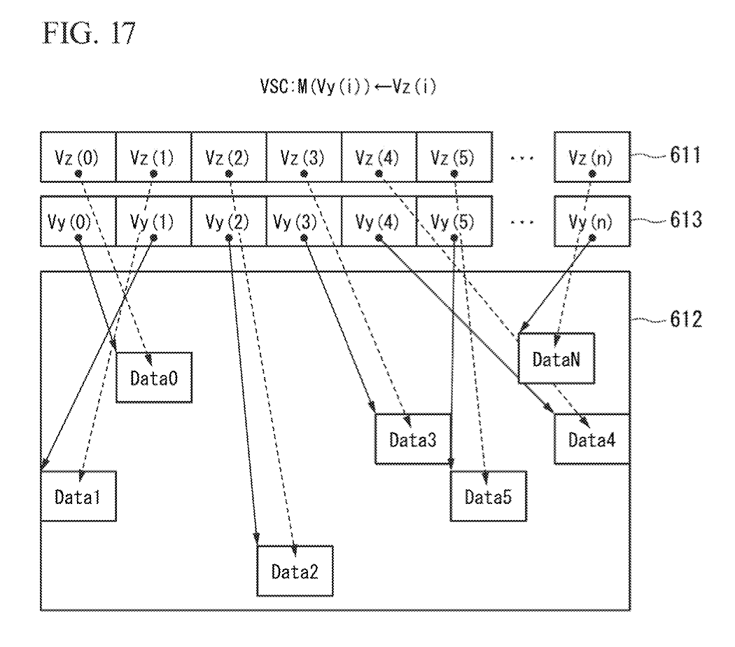

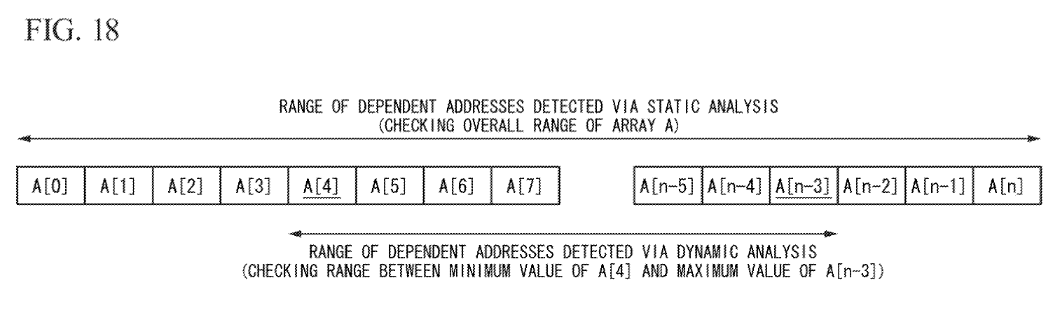

FIG. 15 is a flowchart showing an overtaking determination process according to the third embodiment, solving problems owing to masked operations and changed vector lengths. Steps S301 through S303 shown in FIG. 15 are equivalent to steps S101 through S103 shown in FIG. 7.

In step S304, a decision is made to check whether or not an address dependency source instruction is calculated via a masked operation. When an address dependency source instruction is calculated via a masked operation, calculated minimum/maximum values may not precisely match actual minimum/maximum values among all vector elements of vector registers; hence, the valid/invalid register sections 232 are set to invalid statuses invalidating the contents of the minimum/maximum value register sections 231 in step S306. The subsequent vector gather/scatter instruction does not utilize minimum/maximum values currently set to the minimum/maximum register sections 231; hence, the vector computer does not perform an overtaking control (see steps S307 and S308).

When the address dependency source instruction is not calculated via the masked operation (i.e. when the decision result of step S304 is “NO”), minimum/maximum values and calculation results are written back into the vector registers 211 while the valid/invalid register sections 232 are set to valid statuses validating the contents of the minimum/maximum value register sections 231 in step S305. In step S309, a decision is made to check whether or not the vector length is changed. When the vector length is not changed, minimum/maximum values of the minimum/maximum register sections 231 indicate actual minimum/maximum values among all vector elements of vector registers; hence, the flow proceeds to steps S310 and S311 executing an overtaking control upon dynamically detecting an address dependency source instruction with respect to a subsequent vector gather/scatter instruction.

When a change of the vector length is confirmed in step S309, the flow proceeds to step S312 invalidating the contents of the minimum/maximum register sections 231 with respect to all the vector registers 211. In this case, the vector computer executes the steps S307 and S308 without using the contents of the minimum/maximum value register sections 231 and without performing an overtaking control.

As to the industrial applicability, the present invention is not necessarily limited to vector computers implementing vector gather/scatter instructions but applicable to other types of computers such as scalar computers implementing SIMD instructions (where SIMD stands for “Single Instruction Multiple Data”) having the equivalent functionality as vector gather/scatter instructions.

Lastly, the present invention is not necessarily limited to the foregoing embodiments, which can be further modified in various ways within the scope of the invention as defined by the appended claims.

What is claimed is:

1. A vector computer executing vector operations via vector pipeline processing, comprising:
a minimum/maximum value determination unit that determines minimum/maximum values among vector elements of vector registers based on a result of fixed-point calculation defining an address dependency source instruction in accordance with a vector gather/scatter instruction;
a minimum/maximum value register that stores thminimum/maximum values determined by the minimum/maximum value determination unit; and
an overtaking control unit that specifies an access range of addresses attributed to the vector gather/scatter instruction based on the minimum/maximum values stored in the minimum/maximum value register, thus performing an overtaking control on the vector gather/scatter instruction.

2. The vector computer according to claim 1, wherein the minimum/maximum value determination unit determines the minimum/maximum values during a redUndant time owing to a short turnaround time of the fixed-point calculation compared to a floating-point calculation.

3. The vector computer according to claim 1 further comprising a valid/invalid register indicating whether the minimum/maximum values stored in the minimum/maximum value register are valid or invalid.

4. The vector computer according to claim 1 further comprising a secondary minimum/maximum value determination unit that determines secondary minimum/maximum values among vector elements of the vector registers based on load data of the vector registers.

5. An instruction control method adapted to a vector computer executing vector operations via vector pipeline processing, comprising:
determining minimum/maximum values among vector elements of vector registers based on a result of fixed-point calculation defining an address dependency source instruction in accordance with a vector gather/scatter instruction;
storing the minimum/maximum values determined; and
specifying an access range of addresses attributed to the vector gather/scatter instruction based on the minimum/maximum values, thus performing an overtaking control on the vector gather/scatter instruction.

6. The instruction control method adapted to a vector computer according to claim 5, further comprising:
determining whether the minimum/maximum values are valid or invalid.

7. The instruction control method adapted to a vector computer according to claim 5, further comprising:
determining secondary minimum/maximum values among vector elements of the vector registers based on load data of the vector registers.
